(19) United States
(12) Patent Application Publication
(10) Pub. No.: US 2025/0232637 A1
(43) Pub. Date: Jul. 17, 2025

(54) System and Method for On-demand Game of Chance

(71) Applicants: Grant Alois, Concord, NH (US); Andrew Gadzik, Stratham, NH (US)

(72) Inventors: Grant Alois, Concord, NH (US); Andrew Gadzik, Stratham, NH (US)

(21) Appl. No.: 18/571,321

(22) PCT Filed: May 22, 2023
(86) PCT No.: PCT/US2023/067280

§ 371 Date: Dec. 18, 2023

(51) Int. Cl. G07F 17/32

(52) U.S. Cl. CPC G07F 17/3227; G07F 17/3232

(57) ABSTRACT

A system and method administers an on-demand computerized game of chance for users of an entity. A game administration server is in communication with an entity server having a database of entity users. The game administration server provides an interface for provisioning the game and receiving a player selection criteria. The game administration server provides the player selection criteria to the entity server and in return receives a list of players selected from the entity user database according to the player selection criteria. The selection includes a unique identifier corresponding to the user account of each selected player. The game administration server executes the on-demand game of chance for the selected players.

### FIELD OF THE INVENTION

The present invention relates to inter-entity data administration, and more particularly, is related to an on-demand game of chance.

### BACKGROUND OF THE INVENTION

Many organizations or entities maintain electronic records of persons who interact with the organization via electronic means, for example via the internet, and via applications hosted on devices such as smart phones, computers, or tablets. Entities may include, but are not limited to educational institutions, employers, financial institutions, charities, organizations providing subscription services, and healthcare providers, among others. The persons (generally referred to herein as “users”) who interact with the entities may include students, employees, account holders, donors, subscribers, and patients, among others. The entities may benefit from increased attention from and or interaction with the users. However, reaching out to the users via traditional communication forms, such as emails, text messages, printed publications, and voice calls may not be effective, as many users are regularly inundated with such outreach methods, and therefore such methods may result merely being ignored, or worse, provoking a negative response.

Reward programs have been shown to be an effective outreach method, however, such programs are typically entity specific, and may be cumbersome to manage internally. However, employing third party reward program managers has typically been challenging, both in tailoring rewards programs to a specific entity, and maintaining privacy of entity proprietary user data. Therefore, there is a need to address the above-mentioned shortcomings.

### SUMMARY OF THE INVENTION

Embodiments of the present invention provide a system and method for an on-demand game of chance. Briefly described, the present invention is directed to a system and method for administering an on-demand computerized game of chance for users of an entity. A game administration server is in communication with an entity server having a database of entity users. The game administration server provides an interface for provisioning the game and receiving a player selection criteria. The game administration server provides the player selection criteria to the entity server and in return receives a list of players selected from the entity user database according to the player selection criteria. The selection includes a unique identifier corresponding to the user account of each selected player. The game administration server executes the on-demand game of chance for the selected players.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1 is a schematic diagram of an exemplary first embodiment of a system for an on-demand game of chance.

FIG. 2 is a schematic diagram showing exemplary record data structures for the user database and the game database of FIG. 1.

FIG. 3 is a diagram showing the communication flow amongst system elements under the first embodiment.

FIG. 4A shows an exemplary game administrator user interface entity screen.

FIG. 4B shows an exemplary game administrator user interface game configuration screen.

FIG. 5 is a schematic diagram of an exemplary system for executing the functionality of the game administration server.

FIG. 6 is a flowchart of an exemplary embodiment method of the communication flow of FIG. 3.

FIG. 7 is a schematic diagram of an exemplary second embodiment of a system for an on-demand game of chance.

### DETAILED DESCRIPTION

The following definitions are useful for interpreting terms applied to features of the embodiments disclosed herein, and are meant only to define elements within the disclosure.

As used within this disclosure, an “entity” refers to a human organization, such as a business, an educational institution, a club, a charity, among others.

As used within this disclosure, a “user” is used to refer to a member, subscriber, or client who accesses products and/or services provided by an entity.

As used within this disclosure, an “electronic user interface” refers to an interface on an electronic device (such as a smart phone, computer, tablet, among others). The interface may be provided via a web page browser, a software application, or via a messaging service. The interface may be text based, audio based, and/or graphics based (for example a graphical user interface (GUI)).

As used within this disclosure, a “database record” refers to is a collection of information organized in a table that pertains to a specific topic or category. Another name for a database record is a tuple. A set of records can be referred to as a data set, a data file, and a table, where a record may be a row of the table. A record generally includes a plurality of database fields. It should be noted that while the terms “row” and “column” are useful to analogize a database to a graphical table, the internal data structure of the database may not be tabular.

As used within this disclosure, a “database field” refers to a set of values arranged in a table having the same data type. A field is also known as a column or attribute.

As used within this disclosure, a “game of chance” refers a game where a player's odds of winning are generally determined by the number of entries by that player into an instance of the game, rather than by any skill or strategy of the player. Players are generally selected from a population of users of an entity.

As used within this disclosure, “game rules” refer to a set of rules pertaining to gameplay for a game of chance. For example, game rules for a simple game may involve selecting a set of n entries (for example, alphanumeric characters, colors or shapes), executing a random generator for each of the n entries, and determining if some or all of the selected entries match the generated entries.

As used within this disclosure, a “game administrator” refers to one or more individuals organizing, managing, and executing an on-demand game of chance for entity users. The game administrator may be associated with the entity, or may be independent of the entity.

As used within this disclosure, an “on-demand game of chance” or just “game” refers to a computer based game of chance configurable by a game administrator at a time and/or of a format selected by the game administrator. The game administrator may have additional discretion, for example, determining characteristics of the players admitted to the game, the type of game being offered, and the duration and/or availability of the game.

As used within this disclosure, a “Universally Unique Identifier” (UUID) (also known as a GUID (Globally Unique IDentifier)), refers to a uniquely encrypted numeric identifier. A UUID may be generated by a UUID generating application. For example, the UUID generating application may conform to RFC4122 version 5 UUIDs. A UUID is typically 128 bits long, and can guarantee uniqueness.

As used within this disclosure, a “player” refers to a user of an entity who has been selected to participate in an on-demand game of chance. The entity generally assigns a UUID to each player, where an administrator of the on-demand game of chance is only privy to the UUID of a player, while the entity maintains a mapping associating the UUID with the entity user (player). A “winning player” refers to a player who has won an on-demand game of chance administered by the game administrator.

As used within this disclosure, a “rollover game” refers to an on-demand game of chance where winners of previous (perhaps different) games are automatically entered as players. For example, players in a rollover game (“rollover winners”) may include all previous winners over a specified time window.

Reference will now be made in detail to embodiments of the present invention, examples of which are illustrated in the accompanying drawings. Wherever possible, the same reference numbers are used in the drawings and the description to refer to the same or like parts.

As described in the background section, an entity may wish to encourage its users to be involved with the entity via interaction with a user interface of an electronic device, for example, a computer, a tablet, or a smart phone, among others. Furthermore, the entity may wish to target certain subsets of its users for increased involvement and/or attention. Embodiments of the present invention provide systems and methods that automatically select a subset of users (“players”) from a population of user accounts for inclusion and execution of an on-demand game of chance.

The embodiments assume that the entity has received permission from a population of its users to participate in one or more on-demand games of chance. The embodiments use a criteria set to select a subset of users from the population of users of the entity to provide a game of chance to the selected players, and to execute the game of chance, and to notify the selected players. Under the embodiments, the user notification may inform the players of the criteria used in making the user selection. The desired outcome is for users to increase their involvement with the entity in order to qualify for selection for future games.

Under a first exemplary embodiment, for demonstration purposes the entity is an educational institution, and the users are students enrolled at the educational institution. Under the first embodiment, a subset of students are chosen to be invited to participate in a game of chance. The participants are chosen based on a criteria selected by a game administrator. For example, the criteria may be based on one or more of a grade point average, a class attendance record, and a percentage of completed assignments, among others. Each participant is assigned a unique identifier. The unique identifier may be used, for example, to associate and accumulate values towards a time based reward or prize based on user defined input parameters over specified periods of time.

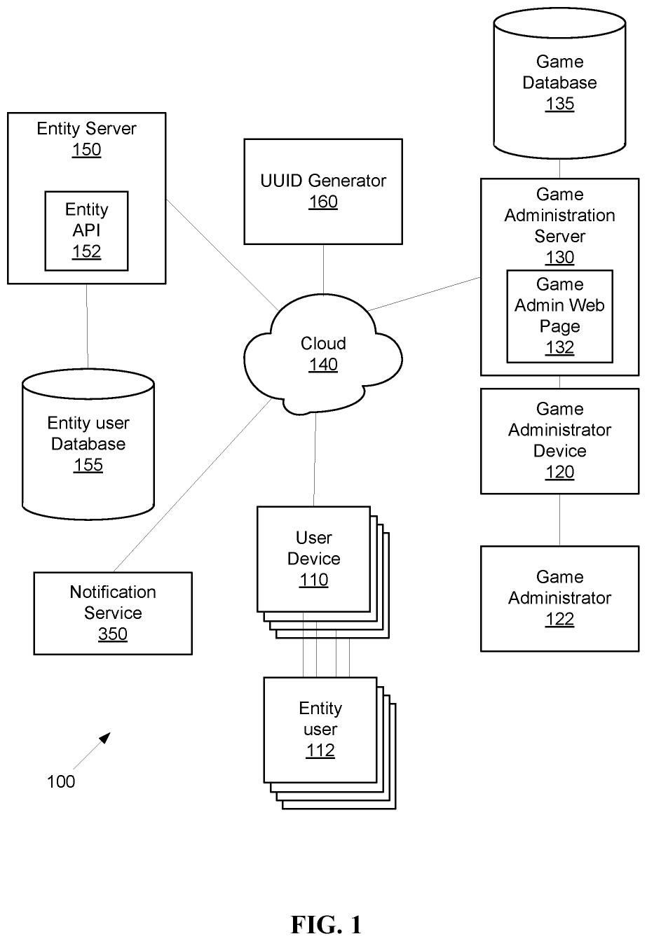

FIG. 1 is a schematic diagram of a first exemplary embodiment of a system 100 for an on-demand game of chance. In general, an on-demand game is set up and administered by a (human) game administrator 122, where the game administrator 122 may be associated with the entity hosting the game, or may be independent of the entity. The game administrator 122 interacts with a game administration server 130 via a game administrator device 120, such as a personal computer 120, for example, via a browser interface hosted by the game administration server 130, or a game administration application hosted by the game administrator device 120.

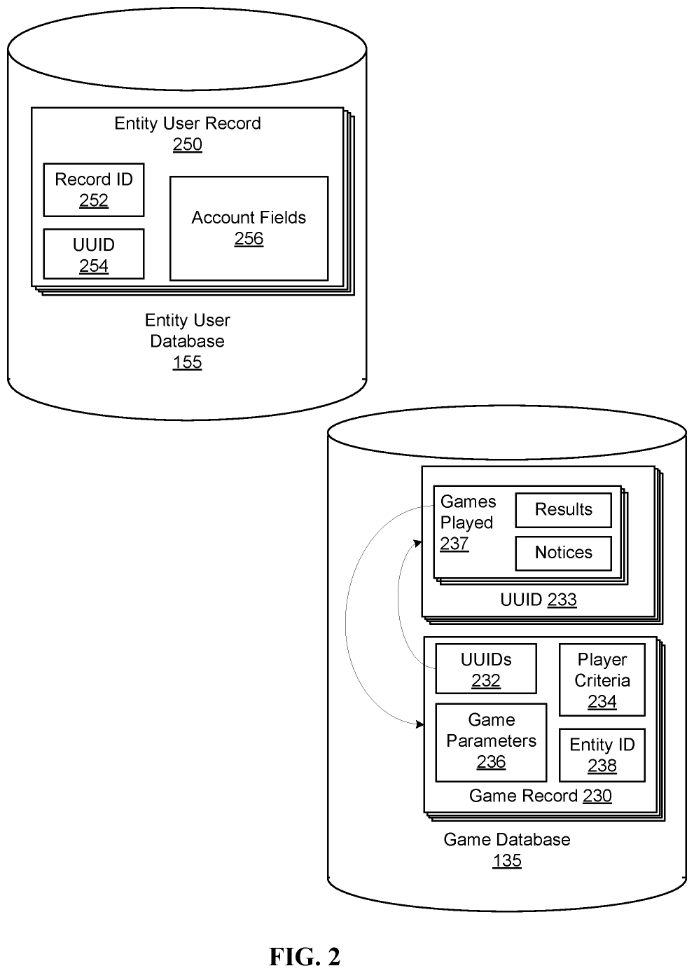

The game administration server 130 may access a game database 135, where the game database 135 contains game records 230 (FIG. 2) pertaining to each game created by the game administrator 122. The game database 135 may be either local to the game administration server 130, or located remotely from the game administration server 130, for example, accessible to the game administration server 135 via a cloud network 140. In an alternative embodiment, the game records 230 may be held in an entity game database (not shown) accessible to the entity server 150.

The game administration server 130 communicates with an entity server 150 via a communication network, depicted here as the cloud 140. Similarly, a plurality of entity users 112 may communicate with an entity server 150 via a communication network via the cloud 140. Under the first embodiment, the game administrator server 130 may not communicate with (or otherwise have access to or awareness of) the user devices 110.

It should be noted that while each of the game administration server 130 and the entity 150 server is depicted as a single server, in practice each may be implemented by one or more server devices, where a plurality of server devices may be co-located or distributed across multiple locations and in communication via the cloud 140.

The entity server 150 may provide access a to user database 155, which under the first embodiment, may be a database of students (entity users 112). The entity server 150 may include an entity application programming interface (API) 152 providing access to the user database 155 via the entity server 150. For example, for each user 112, the user database 155 may have a user record 250 (FIG. 2) corresponding to each entity user 112, the user record 250 containing fields identifying the user (Record ID 252 and UUID 254), and other account fields 256 indicating additional user information, for example, user contact information, and educational records such as current and previously enrolled classes, grade point average, and data regarding individual classes, such as class attendance and assignment completion records, and/or student account balance, among others. Of course, for alternative embodiments for a different type of entity, the account fields 256 are specific to that entity.

At the outset, the game administrator 122 sets parameters for a new game from the game administrator device 120 via the game administration server 130. For example, the game administration server 130 may provide a game administration web page 132 accessible to the game administrator via a web browser application on the game administrator device 120. The game administrator 122 logs into the game administration web page 132 to set parameters for a game and criteria to select users to be invited to participate in the game. In response, as shown by FIG. 2, the game administration server 130 creates a game record 230 in the game database 135 for managing the game. For example, the game record 230 may include game parameters 236, player selection criteria 234, an entity ID associating the game record 230 with the entity (here, the educational institution), and a list of UUIDs 232 corresponding to players (entity users selected for participation in the game). As explained further below, the list of UUID 232 may be provided to the game administrator server 130 by the entity server 150 as a mechanism for shielding the player identity from the game administration server 130. The game administrator may create a UUID record 233 in the game database 135 for each entry in the list of UUIDs 232, where the UUID record 233 includes fields for each game participation 237 associated with this UUID 233, including, for example, results and notifications for each game participation, among other possible fields. The game participation field 237 may include a link back to the corresponding game record 230.

Examples of game parameters 236 may include a game duration, for example, one week or one month, among others. The game administrator 122 determines player selection criteria 234 used to select players from the population of entity users in the entity user database 155, as described later in detail.

The entity server 150 may only provide access to the entity API 152 for pre-approved parties. The entity API 152 may be structured to provide limited access to the entity user database 155. For example, the entity server may provide several tiers of access to the user database 155, where different tiers have access to different records in the user database 155, and/or different fields within a record in the user database 155. The entity API 152 may publish the fields accessible to a particular accessing party. The game administration web page 132 may provide a listing of the accessible fields of the user database to the game administrator, so the game administrator may create the player selection criteria 234 accordingly.

The game administrator 135 may craft an internal player selection criterium to map to a corresponding field of the entity user database 155 made available via the entity API 152. For example, for an entity user record 250 account field 256 of “number of completed credit hours,” the game administrator may set a corresponding player selection criterium such as a minimum completed credit hour threshold, for example, twenty completed credit hours.

Once the game administrator 122 has established the criteria for player selection, the game administrator 122 provides a UUID generation process (in this embodiment, a link to a UUID generator 160) to the entity server 150, and provides the player selection criteria 234 to the entity server 150. A query is provided to the entity user database 155 based on the player selection criteria 234 according to the entity API 152. The database query is used to access the entity user records 250. The entity user database 155 responds to the query with a query response identifying potential players from the entity user records 250 according to the entity user account fields 256 filtered via the player selection criteria 234.

Under the first embodiment, examples of player selection criteria 234 may include, a threshold or range, for example, a minimum number of enrolled classes or class credit hours, a minimum number of assignments turned in, and assignment completion percentage, or a minimum account balance, among other criteria. This exemplary criteria is for the first embodiment where the entity is an educational institution. In a first alternative embodiment where the entity is a gym, an exemplary criteria may include a number of user visits to the gym per month, and progress toward specific fitness goals, among others. In a second alternative embodiment where the entity is a bank, an exemplary criteria may include a number of transactions per month, average account balances, and progress toward specific financial goals, among others. Of course, the criteria for a specific entity are generally based on the data available to the game administration server 130 via the entity API 152.

The database query response may provide a selection of one or more players from the entity users 112. The entity server 150 calls the UUID generator 160 to obtain a UUID for each selected player. The entity server 150 maintains a mapping of each UUID to each selected player. For example, the entity server 150 may store the UUID in a UUID field 254 of the entity user record 250 for the corresponding player.

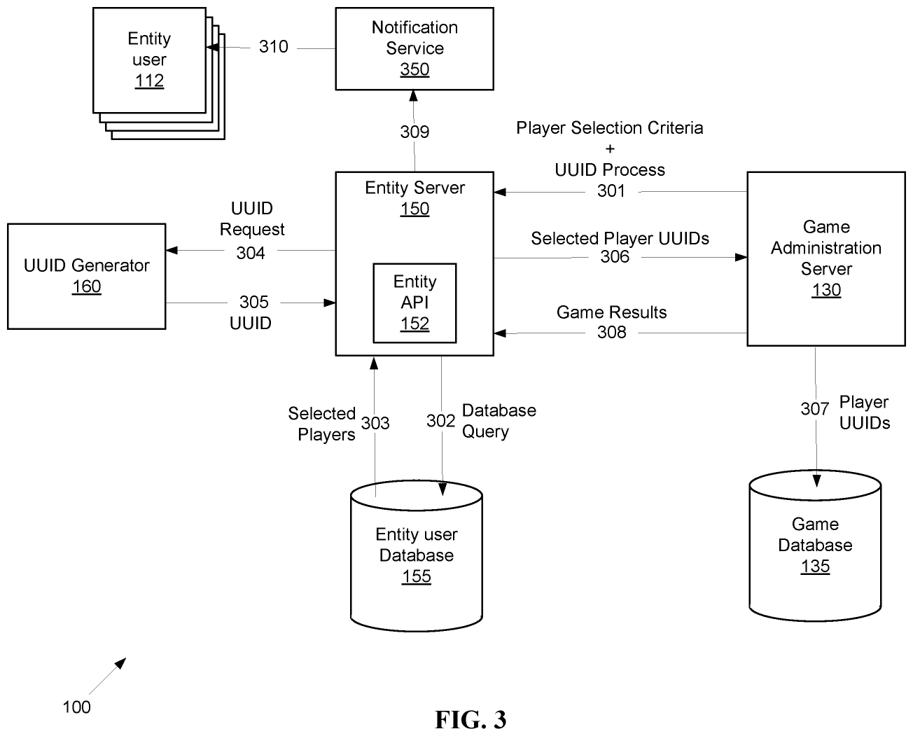

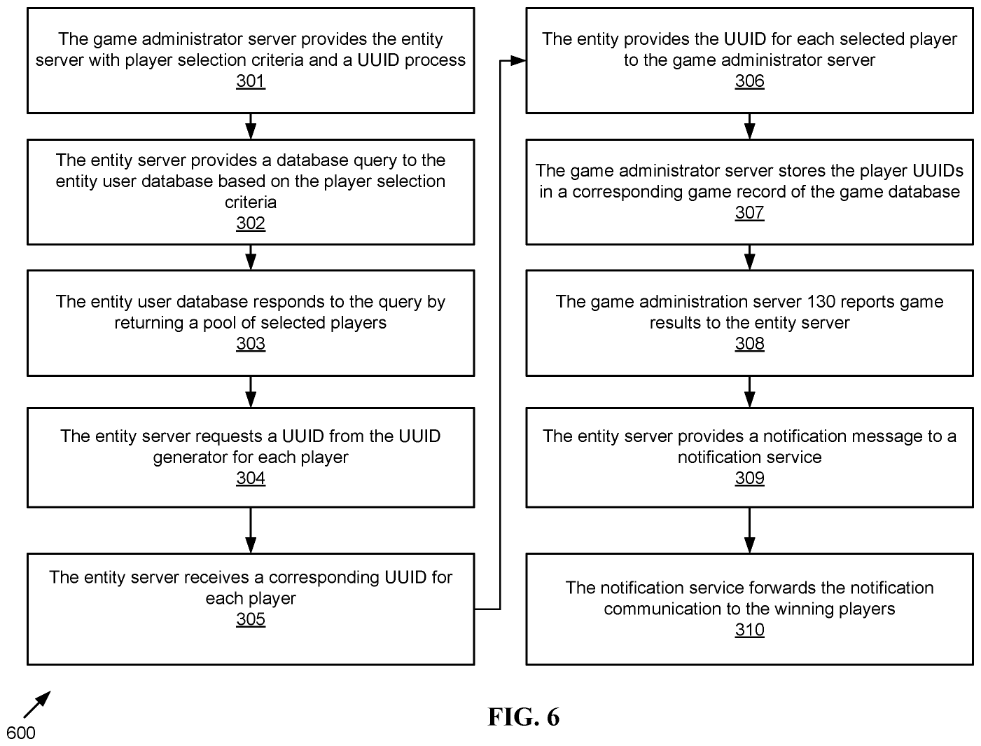

FIG. 3 is diagram 300 summarizing data communication steps amongst elements of the system 100. FIG. 6 is a flowchart of a corresponding method embodiment. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A game administrator 122 (FIG. 1) formulates an on-demand game of chance, including player selection criteria 234 (FIG. 2) for the game. The game administrator server 130 provides the entity server 150 with the player selection criteria 234 and a UUID process (block 301). The entity server 150 provides a database query to the entity user database 155 based on the player selection criteria 234 (block 302). The entity user database 155 responds to the query by returning a pool of selected players (block 303). The entity server 150 requests a UUID from the UUID generator 160 for each player (block 304) and receives a corresponding UUID (block 305). The entity provides the UUID for each selected player to the game administrator server 130 (block 306). The game administrator server 160 stores the player UUIDs 232 in a corresponding game record 230 (FIG. 2) of the game database 135 (block 307). The game administrator 122 (FIG. 1) executes the game play, and the game administration server 130 reports the game results to the entity server 150 (block 308). For example, the game results may include a list of UUIDs for the winning players, a prize associated with each winning player, and/or a notification communication for the winning players. The entity server 150 provides a notification message to a notification service 350, for example, a third party email/SMS gateway (block 309). Alternatively, the notification service 350 may be an internal function of the entity server 150. The notification service 350 forwards the notification communication to the winning players 112 (block 310), as described further below.

Since under the first embodiment the game administrator 122 is not privy to the identity (and contact information) of the players (entity users 112), the game administrator 122 cannot directly notify winning players of the results of an on-demand game of chance. Instead, the game administrator may provide a notification communication to the entity server 150. For example, the notification communication may be a form letter associated with the UUID for each winning player. The game administration server 130 may provide the winner communication to the entity server 150, where the entity server 150 uses the UUID to retrieve the user data of the winning player from the entity user record 250 of the winning player in the entity user database 155. The entity server 150 then proceeds to notify the winning player with the winner communication populated with data from the entity user record 250. The entity server 150 may employ a third party email/SMS gateway to contact the winning player according to a provided preferred communication method supplied by the entity user 112. For example, the preferred communication method for each entity user 112 may be stored in the account fields 256 of the entity user record 250 of the winning player. The account fields 256 may be updated to record the results of each game participation.

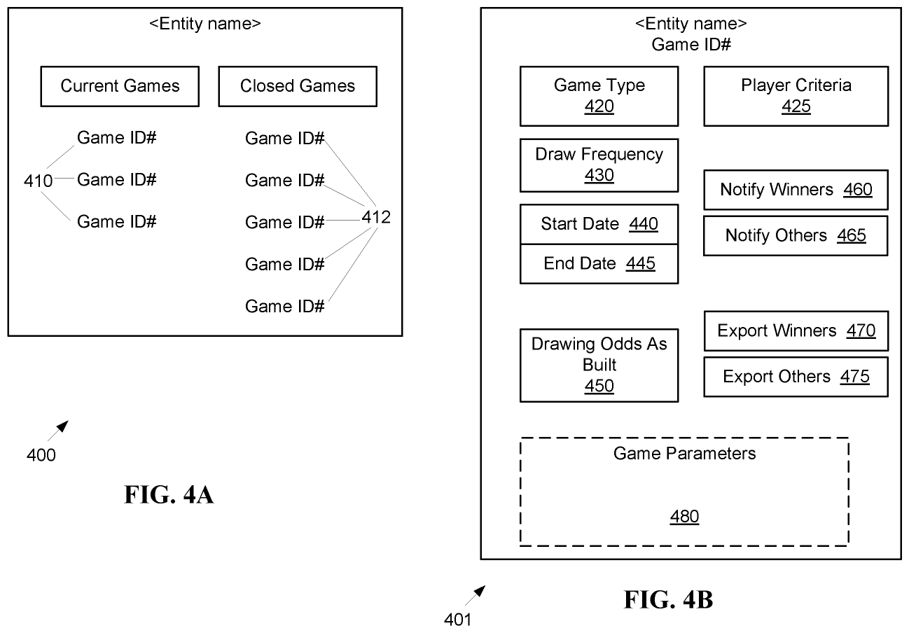

FIG. 4A shows an exemplary game administrator user interface entity screen 400 to be displayed on the game administrator web page 132 (FIG. 1). Here, the game administrator 122 may monitor current and closed games for an entity. For example, the screen 400 may display a list of current games links, 410, and a list of closed game links 412, for example, provided in a drop-down list. Upon selection of one of the links 410, 412, the game administrator 122 is presented with a game configuration screen 401 (FIG. 4B) for the selected game.

FIG. 4B shows an exemplary game administrator user interface game configuration screen 401 for display on the game administrator web page 132 (FIG. 1). Here, the game administrator 122 may configure the parameters of an on-demand game of chance for a specified entity. The game administrator may select the game type 420, where the screen presents a selection of pre-configured games, for example, via a drop-down menu. If the selected game type is “custom,” the game configuration screen may present one or more game parameters 480, providing details of the custom game.

The player criteria item 425 may bring up a screen where the game administrator 122 may select criteria from a presented list of parameters specific to the entity. For example, the presented player criteria may draw from a plurality of fields provided by the entity according to the entity API 152 (FIG. 1). The game administrator server 130 receives the player criteria 425 entered by the game administrator 122 and may formulate a query for the entity user database 155 (FIG. 1) to select a plurality of players from the population of entity users 112 (FIG. 1) based on the player criteria 425.

The game configuration screen 401 also includes fields regarding game administration parameters, for example, draw frequency 430, start date 440, and end date 445. For example, selecting draw frequency 430 may result in display of a drop down menu with game draw frequencies, for example, daily, weekly (calendar), weekly (business), or monthly, and selecting the start date 440 or end date 445 may cause a calendar selection box to appear. A drawing odds as built field 450 presents the probability of a player winning the game. Several fields are also presented directed to the results of the game, including notification controls 460, 465 to specify how winners 460 and non-winners are notified of the game results. Similarly, the export winners field 470 and the export others field 475 may be used to generate reports regarding the outcome of a completed game in a desired format, for example, CSV, Excel, and XML, among others.

It should be noted that under alternative embodiments the entity screen 400 and the game configuration screen 401 may include more or fewer displayed interface controls, and/or the displayed interface controls may be different, for example, based on the entity and game type.

The player selection criteria 234 may further include levels establishing a multiple of game entries for the user, for example, awarding an additional game entry for each completed assignment over the minimum threshold. Other thresholds may be established to reward user longevity, for example, how long the user account has been open. In an alternative embodiment where the entity is a bank, the administrator may select multipliers for the new game (for example, an additional entry is awarded for every $100 over the $250 minimum account balance).

Under the first embodiment, the game administration server 130 may provide more than one type of game. Here, the game administrator 122 may choose the style of game type from a predefined list of game types. Optionally, the game administration server 130 may have provisions for the game administrator 122 to create a custom game where the game administrator 122 may define at least some game parameters. For example, the game administrator 122 may set up a custom game which presents the user with a grid displaying a configurable number of rows and columns of cells, each cell containing alphanumeric characters to be matched against a randomized drawing. As another example, the game administrator 122 may use the custom game option to create a game where winners are selected based on a specified time based criteria, or winners based on accumulation of matching alphanumeric characters.

Examples of non-random winner(s) based purely on account history and deposit size could be number matching games or alphabet matching games and include rollover winners. Additionally, non-random winners may be selected based on transaction types that occur in the entity account of the user. For example, if the entity is a bank, the entity account of the user may be a deposit account. Here a non-random winner may be selected based upon certain activity in the deposit accounts, such as transaction with a specific or with specified merchant categories, debit card usage, and other activity.

For character matching games, the game administrator 122 may define how often the alphanumeric characters are drawn to begin accumulation. The game administration server 130 receives the game parameters input by the game administrator 122 and consolidates the game parameters into an internal set of game rules.

The present embodiments provide advantages over previous online game systems, where random drawings are not customizable to a target subset of account holders and thereby effective toward user engagement and retention goals. Actively and automatically updating the pool of players avoids cumbersome exports and data scrubbing. The embodiments also allow for multiple tiers and chances as described, in contrast to, for example, a set amount of ‘tickets’ raffled off and selected at random which typically involves a significant data export and manual organization. The present embodiments advantageously work with any core system that has an exposed API, in contrast with existing custom one-off solutions.

While the exemplary embodiments described above are directed to an educational organization, alternative embodiments may be directed to any number of other verticals where entities wish to provide positive customer/member engagement and parameters customizable to the specific entity.

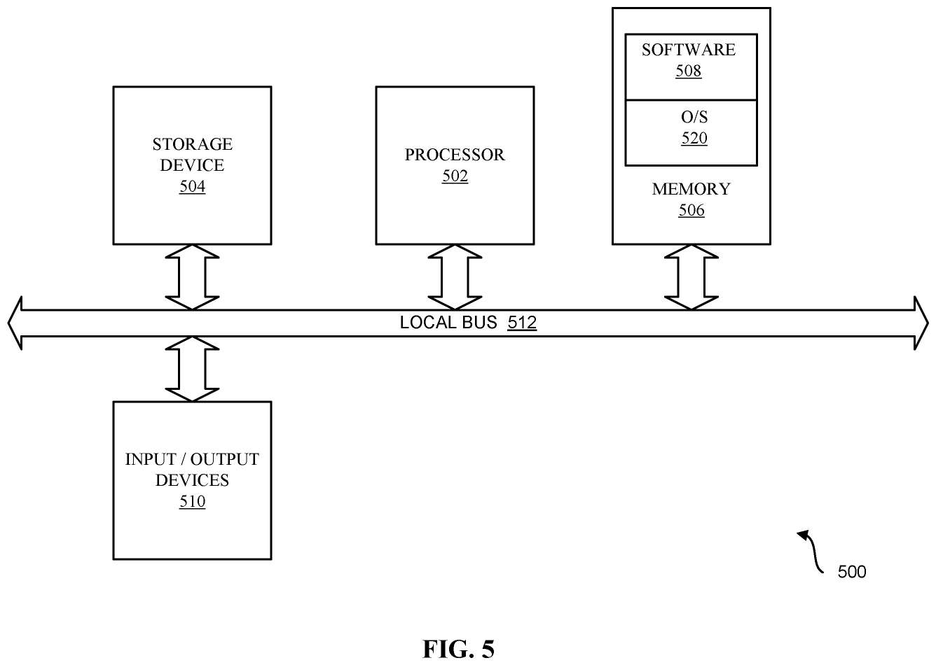

A system for executing the functionality described in detail above may be a computer, an example of which is shown in the schematic diagram of FIG. 5. The system 500 contains a processor 502, a storage device 504, a memory 506 having software 508 stored therein that defines the abovementioned functionality, input, and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

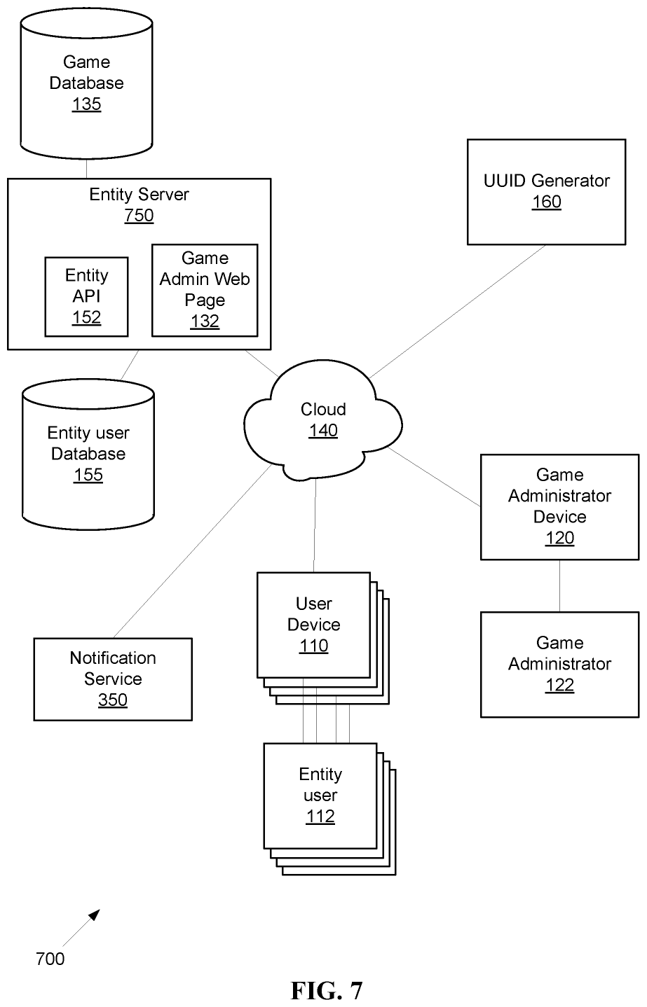

While the first embodiment system 100 (FIG. 1, described above) is directed to a system where the game administration server 130 is distinct and separate from the entity server 150 and in communication with the entity server 150 via a communication network 140, under a second embodiment 700 (FIG. 7) the above described functionality of game administration server 130 may be incorporated into the entity server 750 and/or the game administration server is co-resident with the entity server 750. For example, the game administrator server may be implemented as a software component within the entity server 750, where the entity server 750 may be hardware based. Here, the entity server 750 may host the game administrator web page 132. Similarly, the game database 135 and the game administrator device 120 may be directly connected to the entity server 750. However, under the second embodiment, the game administrator 122 may still not be privy to the entity user database 155 (other than via the entity API 152), and accordingly, the game administrator 122 may not be privy to the account information for the entity users 112. As with the first embodiment, under the second embodiment the only link the game administrator 122 may have to an entity user is via a UUID. While FIG. 7 shows the game administrator device 120 in communication with the entity server 750 via an external network 140, in alternative embodiments the game administrator device 120 may communicate with the entity server 750 directly, or via a local area network of the entity. The second embodiment system 700 may be functionally identical to the first embodiment system 100 (FIG. 1). Practically, both embodiments provide an application for administering an on-demand game of chance for entity users without divulging potentially sensitive entity user information to the game administrator.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for administering an on-demand computerized game of chance for an entity to a plurality of players selected from a plurality of entity users, each entity user having a computer based account stored in an entity user database accessible via an entity server, comprising:
a game database accessible to a game administration server;
the game administration server in communication with the entity server, the game administration server further comprising a processor and a memory storing non-transient instructions that when executed by the processor:
provides a game administrator interface for a game administrator for provisioning the on-demand game of chance, the game administrator interface further providing:
access to the entity server; and
an interface for the game administration server to receive player selection criteria from the game administrator;
provides the player selection criteria to the entity server;
receives a selection of players from the entity server corresponding to the player selection criteria, wherein the selection comprises a unique identifier corresponding to the user account of each selected player; and
executes the on-demand game of chance for the selected players,
wherein the game database is configured to store a plurality of rules for the on-demand game of chance.

2. The system of claim 1, wherein the player selection criteria is mapped to an entity application programming interface (API) for the entity server.

3. The system of claim 1, further comprising a game data structure comprising:
the plurality of rules corresponding to the on-demand game;
the player selection criteria; and
for each player of the plurality of game players, a record further comprising;
the unique identifier for the player.

4. The system of claim 1, wherein the game administrator interface configured to:
provide a predefined selection of a game formats to the game administrator for the on-demand game of chance, the plurality of predefined game formats comprising the plurality of rules for the on-demand game.

5. The system of claim 1, wherein the game administrator interface is configured to receive a game format comprising the plurality of rules for the on-demand game from the game administrator.

6. The method of claim 1, wherein the player selection criteria consists of at least one of the group of a minimum value of a field of a user record in the entity user database, and a maximum value of the field of the user record in the entity user database.

7. The system of claim 1, wherein the unique identifier comprises a Universally Unique Identifier (UUID), and the game administrator interface is further configured to provide the entity server means for generating UUIDs for the selected players.

8. The system of claim 1, wherein the game administration server is co-resident with the entity server.

9. A method for administering an on-demand game of chance for a plurality of players selected from a plurality of entity users having a computer based account with an entity, the method comprising the steps of:
providing a game administrator interface for a game administrator to provision the on-demand game of chance, the game administrator interface further providing:
access to the entity server; and
an interface for the game administration server to receive player selection criteria from the game administrator;
mapping the player selection criteria to an entity application programming interface (API) for the entity server;
providing the API mapped player selection criteria to the entity server;
receiving a selection of players from the entity server, wherein the selection comprises a unique identifier corresponding to the user account of each selected player; and
executing the on-demand game of chance for the selected players.

10. The method of claim 9, further comprising the step of receiving a selection by the game administrator of a game format for the on-demand game of chance from a plurality of predefined game formats comprising a plurality of rules for the on-demand game.

11. The method of claim 9, further comprising the step of receiving a game format from the game administrator comprising a plurality of rules for the on-demand game.

12. The method of claim 9, further comprising the step of storing the plurality of rules for the on-demand game in a game database.

13. The method of claim 12, further comprising the step of storing the unique identifier in the game database.

14. The method of claim 9, wherein the player selection criteria consists of at least one of the group of a minimum value of a field of a user record in the user database, and a maximum value of the field of the user record in the user database.

15. The method of claim 12, further comprising the step of providing the results of the on-demand game of chance to the entity.

16. The method of claim 9, wherein the unique identifier comprises a Universally Unique Identifier (UUID), and the game administrator interface is further configured to provide the entity server means for generating UUIDs for the selected players.

17. The method of claim 9, further comprising the step of providing the entity server results of the on-demand game of chance, comprising UUIDs of winning and losing players from the selected players.
